(19) United States
(12) Patent Application Publication
(10) Pub. No.: US 2016/0029745 A1
(43) Pub. Date: Feb. 4, 2016

(54) CLIP SET FOR RETAINING THE TIGHTNESS OF A LACED SHOE

(71) Applicant: Bartholomew John Atherinos, Windsor (AU)

(72) Inventor: Bartholomew John Atherinos, Windsor (AU)

(21) Appl. No.: 14/446,354

(22) Filed: Jul. 30, 2014

(51) Int. Cl. A43C 7/08; F16B 2/22

(52) U.S. Cl. CPC A43C 7/08; F16B 2/22

(57) ABSTRACT

A clip set for retaining the tightness of a laced shoe resulting from the tightening of a shoelace looped through shoelace eyelets of a shoe. The set comprises a pair of clip devices, each of which comprising a pair of thorough holes disposed thereon and a pair of opposingly-disposed, elongate, collinear, open slits disposed thereon, each slit extending between a hole and the boundary of the device whereby, a hole is rendered radially open via the slit connected thereto.

### CROSS-REFERENCE TO RELATED APPLICATIONS

This application claims benefit of priority of U.S. Application 61/860,926 filed on Aug. 1, 2013 entitled “Shoe Lace Clip” owned by the assignee of the present application and herein Incorporated by reference in its entirety.

### BACKGROUND

### Field of the Invention

The present invention relates to footwear accessories, and more particularly to a clip set for retaining the tightness of a laced shoe irrespective of the shoelace being tied or knotted.

Shoelaces often easily loosen or even come undone thus requiring the wearer of the shoe to re-tie them as often. Adding fuel to fire, today, most of the shoes come with lengthy laces leaving a substantial leftover even after being looped through all the shoelace eyelets of the shoe. As a result of this, the shoelaces, after being tied, leave a larger bow wherein, the chances of the larger bow becoming undone are increased as it is easier for the larger bow to catch onto something or come between the sole of the shoe and the ground. To counter the aforesaid problems of the larger bow, a smaller bow is tied and the lace left over from the smaller bow is tucked between the shoe and the foot. Although proved to be a better alternative, it is very annoying to experience the leftover shoelace touching the feet all the time. All in all, managing shoelaces is a quite a hassle that has been bothering people for very long and there has not been any noteworthy solution for it yet.

### SUMMARY

The present invention comprises a clip set that aims to address the long-felt need of managing the shoelaces. The clip set comprising a pair of clip devices is purposed to retain the tightness of a laced shoe by coupling each of the pair of left over untied or unknotted shoelace with a device. The device comprises a resilient, flat, thin, rectangular member comprising a pair of thorough holes disposed thereon wherein, a hole is adapted to snugly receive a shoelace therethrough. The device further comprises a pair of narrow, elongate, collinear slits, each extending between a hole and the boundary edge of the device whereby, the hole can be radially accessed through the slit. The slit is dimensionally configured such that, when a shoelace is received within the slit and is manually traversed along the length thereof, the slit flexes itself allowing the shoelace to traverse therealong.

In order to use the clip set on a shoe, each of the two free extremity portions or leftover portions of each untied or unknotted shoelace is looped through the pair of holes. Thereafter, upon manually holding the extremity of the shoelace and manually pulling the same away from the last eyelet (from which the leftover portion of the shoelace proceeds) in order to straighten the leftover portion, the device is manually moved towards the last eyelet and simultaneously away from the extremity of the shoelace. At this point, the friction between the shoelace and the holes prevents the leftover portion of the shoelace from being retracted into the last eyelet thereby, retaining or locking the tightness of the shoe.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a perspective view of the clip device.

FIG. 2, according to an embodiment of the present invention, is an illustration of a planar view of the clip device.

FIG. 3, according to an embodiment of the present invention, is an illustration of the device coupled to a shoelace.

FIG. 4, according to an embodiment of the present invention, is an illustration of a perspective view of the clip set.

FIG. 5, according to an alternate embodiment of the present invention, is an illustration of a perspective view of the clip device.

FIG. 6, according to an alternate embodiment of the present invention, is an illustration of a planar view of the clip device.

### FIGURES—REFERENCE NUMERALS

10—Clip Device
12—Hole
14—Slit
16—Laced Shoe
18—Shoelace
20—Eyelet
22—Extremity Portion

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

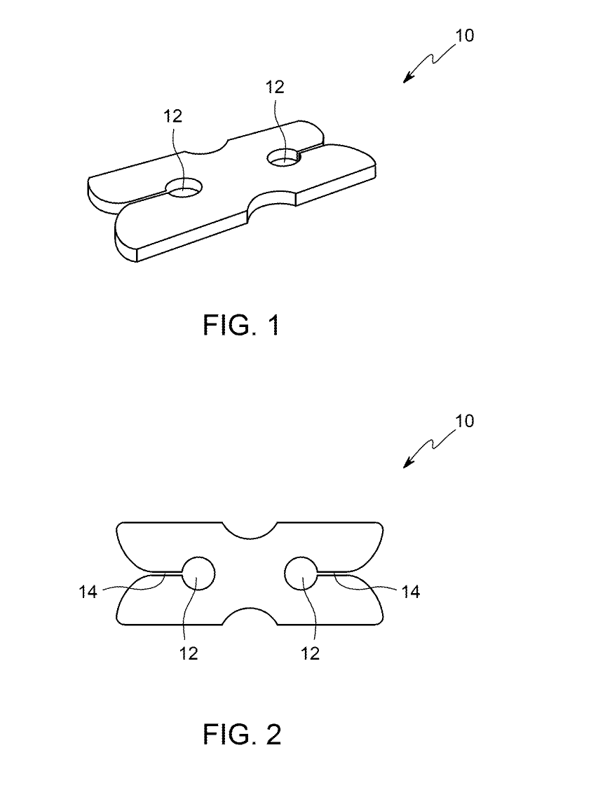

The present invention comprises a clip set for securing, locking, anchoring, or retaining the tightness of a laced shoe resulting from the tightening of a shoelace looped through shoelace eyelets of the shoe. Notably, the clip set is designed to retain the tightness of the shoe irrespective of the lace being tied or knotted. Referring to FIGS. 1 and 2, the clip set comprises a pair of resilient, flat, relatively thin, substantially rectangular clip devices 10, each of which defined by a pair of planar top and bottom surfaces and a relatively thin, uniform boundary edge extending between the top and bottom surfaces. On account of each device being substantially rectangular shaped, each device comprises a pair of longer and shorter sides. Each device is preferably made of a polymeric composition.

Still referring to FIGS. 1 and 2, each device 10 comprises a pair of thorough circular holes 12 extending through the top and bottom surfaces wherein, each hole 12 is adapted to snugly receive a shoelace therethrough. Each device 10 further comprises a pair of opposingly-disposed, elongate, relatively narrow, collinear slits 14 wherein, each slit 14 extends between a hole 12 the boundary edge thereby rendering the corresponding hole radially open. In other words, from the boundary edge of the device 10, the hole 12 can be radially accessed through the slit 14. As mentioned earlier, as the device 10 is made of a resilient material, when a shoelace received therewithin is manually traversed along the length thereof, the slit 14 flexes itself allowing the shoelace to pass therethrough. Each slit 14 divides a shorter side into two halves wherein, the boundary edge of each half of the shorter side has a convex curvature as seen more clearly in FIG. 2.

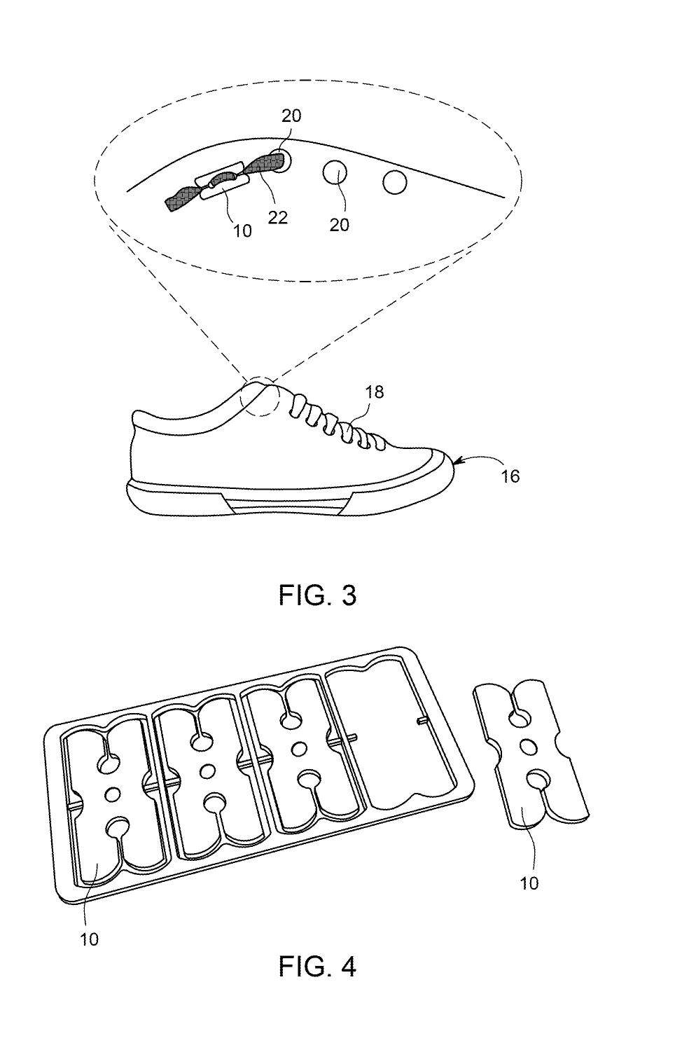

Referring to FIG. 3, in order to use the clip set on a laced shoe 16 comprising a shoelace 18 looped through the shoelace eyelets 20 thereof, each of the two free extremity portions 22 (or leftover portions) of an unknotted shoelace 18 (looped through the eyelets 20) is looped through the pair of holes 12 (FIGS. 1 and 2) of a device 10. Thereafter, upon manually holding the extremity of the shoelace 16 and manually pulling the same away from the last eyelet 20 (from which the extremity portion 22 of the shoelace 18 proceeds) in order to straighten the extremity portion 22 of the shoelace 18, the device 10 is manually moved towards the last eyelet 20 and simultaneously away from the extremity of the shoelace 18. At this point, the friction between the shoelace 18 and the holes 12 (FIGS. 1 and 2) prevents the extremity portion 22 of the shoelace 18 from being retracted into the last eyelet 20 thereby, retaining tightness of shoe 16.

The slits 14 (FIGS. 1 and 2) make it easier to further tighten the shoe 16 (by the shoelace 18) as it is easier to remove the shoelace 18 through the slit 14 (FIGS. 1 and 2) as opposed to removing through just the hole 12 (FIGS. 1 and 2) in the absence of the slit 14 (FIGS. 1 and 2). As seen in FIG. 4, the devices 10 are preferably packaged as a set of four or a set of two clip sets wherein, each clip set sufficiently serves a shoe.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

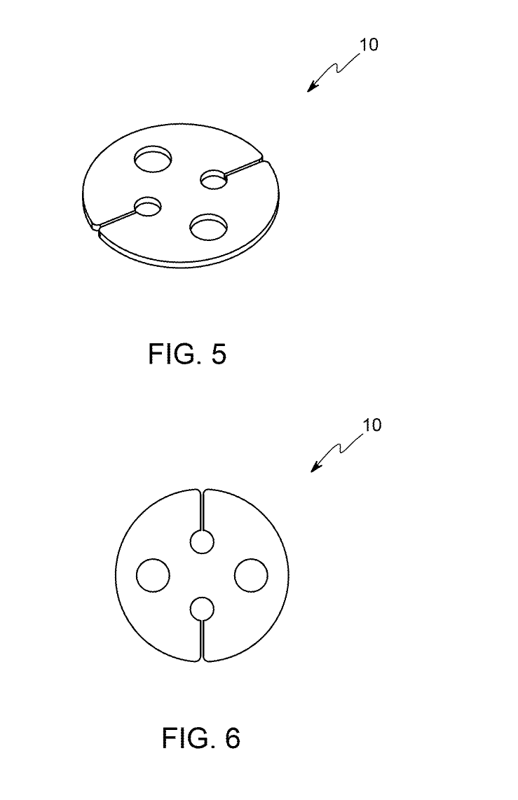

Although the embodiments herein are described with various specific embodiments, it will be obvious for a person skilled in the art to practice the invention with modifications. For example, the device 10 instead of being rectangular may be designed to be circular as seen in FIGS. 5 and 6. However, all such modifications are deemed to be within the scope of the claims.

What is claimed is:

1. A clip set for retaining the tightness of a laced shoe resulting from the tightening of a shoelace looped through shoelace eyelets of a shoe, the set comprising a pair of clip devices, each of which comprising:
(a) a pair of thorough holes disposed thereon; and
(b) a pair of opposingly-disposed, elongate, colinear, open slits disposed thereon, each slit extending between a hole and the boundary of the device whereby, a hole is rendered radially open via the slit connected thereto;
wherein, as each free extremity portion of a looped shoelace is coupled with a device as each extremity portion of a shoelace is looped through the pair of holes of a device and as the device, upon receiving the shoelace, is manually moved towards the eyelet from which the free extremity portion of the shoelace is proceeding and simultaneously moved away from the free extremity of the shoelace, owing to the friction between the shoelace and the pair of holes, the free extremity portion is prevented from being retractracted into the eyelet thereby retaining the tightness of a laced shoe.

2. The set of claim 1 wherein, the device comprises a flat planar structure.

3. The set of claim 2 wherein, the device is substantially rectangular and whereby comprises a pair of shorter and a pair of longer opposingly-disposed sides.

4. The set of claim 3 wherein, the slit divides a shorter side into two halves.

5. The set of claim 4 wherein, the edge of each half of a shorter side comprises a convex curvature.

6. The set of claim 2 wherein, the device is substantially circular.

7. The set of claim 1 wherein, the hole is circular.

8. The set of claim 1 wherein, the device is of light polymeric composition.

9. The set of claim 1 wherein, the device is resilient.

10. A clip set for retaining the tightness of a laced shoe resulting from the tightening of a shoelace looped through shoelace eyelets of a shoe, the set comprising a pair of resilient, flat, planar, rectangular clip devices, each of which comprising:
(a) a pair of thorough circular holes disposed thereon; and
(b) a pair of opposingly-disposed, elongate, colinear, open slits disposed thereon, each slit extending between a hole and the boundary of the device whereby, a hole is rendered radially open via the slit connected thereto, each slit being thorough as the a hole;
wherein, as each free extremity portion of a looped shoelace is coupled with a device as each extremity portion of a shoelace is looped through the pair of holes of a device and as the device, upon receiving the shoelace, is moved towards the eyelet from which the free extremity portion of the shoelace is proceeding and simultaneously moved away from the free extremity of the shoelace, owing to the friction between the shoelace and the pair of holes, the free extremity portion is prevented from being retractracted into the eyelet thereby retaining the tightness of a laced shoe.

11. A clip set for retaining the tightness of a laced shoe resulting from the tightening of a shoelace looped through shoelace eyelets of a shoe, the set comprising a pair of resilient, flat, planar, circular clip devices, each of which comprising:
(a) a pair of thorough circular holes disposed thereon; and
(b) a pair of opposingly-disposed, elongate, colinear, open slits disposed thereon, each slit extending between a hole and the boundary of the device whereby, a hole is rendered radially open via the slit connected thereto, each slit being thorough as the a hole;
wherein, as each free extremity portion of a looped shoelace is coupled with a device as each extremity portion of a shoelace is looped through the pair of holes of a device and as the device, upon receiving the shoelace, is moved towards the eyelet from which the free extremity portion of the shoelace is proceeding and simultaneously moved away from the free extremity of the shoelace, owing to the friction between the shoelace and the pair of holes, the free extremity portion is prevented from being retractracted into the eyelet thereby retaining the tightness of a laced shoe.
